(19) United States
(12) Patent Application Publication
(10) Pub. No.: US 2026/0097975 A1
(43) Pub. Date: Apr. 9, 2026

(54) Combined Electrodialysis and Reverse Osmosis CERO

(71) Applicant: Ben Harrison Cantrell, Springfield, VA (US)

(72) Inventor: Ben Harrison Cantrell, Springfield, VA (US)

(21) Appl. No.: 19/417,701

(22) Filed: Dec. 12, 2025

(51) Int. Cl. C02F 1/469; C02F 1/44

(52) U.S. Cl. CPC C02F 1/4693; C02F 1/441; C02F 2201/004; C02F 2201/005; C02F 2209/10; C02F 2301/08

(57) ABSTRACT

Previous patent applications described, by way of examples, a Combined Electrodialysis and Reverse Osmosis (CERO) system capable of extracting 100% of the water in the saline feedwater as desalinated water and all its dissolved salt as solid salt. These examples only cover one special case of the reverse osmosis system operating with a 50% water-recovery factor of its input water. The present invention extends this principle, illustrated by narrow in scope examples, to accommodate any permissible RO water-recovery factor. In addition, whereas earlier descriptions of the CERO process required a cyclic sequence of serial operations, the invention further provides an implementation in which those cyclic operations are performed concurrently while achieving the same overall functional result.

### CROSS-REFERENCE TO RELATED APPLICATIONS

Patent application Ser. No. 18/128,382, Ben Harrison Cantrell, “Gated Electrodialysis with Zero Liquid Discharge,” Filed Mar. 30, 2023, Publication Number US-2024-0327257-A1, Publication Date Oct. 3, 2024

Patent application Ser. No. 18/679,573, Ben Harrison Cantrell, “Alternate Water Distributions in Electrodialysis Systems with ZLD Properties,” Filed May 31, 2024

Patent application Ser. No. 19/169,242, Ben Harrison, Cantrell, “Electrodialysis with Perpendicular Water Flow and No Leaks”, Filed Apr. 3, 2025, Publication Number U.S. Pat. No. 20,250,256993-A1, Publication Date 2025 Aug. 14

### FEDERALLY SPONSORED RESEARCH OR DEVELOPMENT

Not applicable

### REFERENCE TO A “SEQUENCE LISTING”

Not Applicable

### NAMES OF THE PARTIES TO A JOINT RESEARCH AGREEMENT

Not Applicable

### INCORPORATION-BY-REFERENCE OF MATERIAL SUBMITTED ON A COMPACT DISC OR AS A TEXT FILE VIA THE OFFICE ELECTRONIC FILING SYSTEM (EFS-WEB)

Not Applicable

### STATEMENT REGARDING PRIOR DISCLOSURES BY THE INVENTOR OR A JOINT INVENTOR

Not Applicable

### BACKGROUND

Field of the Invention: This invention is in the field of electrodialysis and reverse osmosis with applications to desalination.

Description of the Related Art: Electrodialysis (ED) systems transport dissolved salt (ions) in water from a stream with lower ion concentration to a stream with higher ion concentration. Reverse osmosis (RO) systems separate an input saline feedwater stream into: (1) a product desalinated water stream containing a portion of the water in the RO feedwater and almost no dissolved salts, and (2) an ion-enriched water stream that contains (a) essentially all the dissolved salts originally present in its feedwater and (b) the other portion of the water in its feedwater. Three patent applications found in the INFORMATION DISCLOSURE STATEMENT BY APPLICANT (Form PTO/SB/08a) are relevant to this invention; these are:
patent application Ser. No. 18/128,382, Ben Harrison Cantrell, “Gated Electrodialysis with Zero Liquid Discharge,” Filed Mar. 30, 2023, Publication Number US-2024-0327257-A1, Publication Date Oct. 3, 2024 (Description relative to FIG. 43)
patent application Ser. No. 18/679,573, Ben Harrison Cantrell, “Alternate Water Distributions in Electrodialysis Systems with ZLD Properties,” Filed May 31, 2024, Unpublished (Description relative to FIG. 28)
patent application Ser. No. 19/169,242, Ben Harrison, Cantrell, “Electrodialysis with Perpendicular Water Flow and No Leaks”, Filed Apr. 3, 2025, Publication Number U.S. Pat. No. 20,250,256993-A1, Publication Date 2025 Aug. 14 (Description relative to FIG. 19)

All three cited patent applications describe, by an example, a combined electrodialysis (ED) and reverse osmosis (RO) CERO system that achieves 100% recovery of the water in the saline feedwater and converts all the feedwater's dissolved salts into solid salt for a special case. The CERO system operated cyclically through a series of repeated steps.

The prior patent applications described the CERO process using an illustrative example for a water recovery factor of 0.5 (50%). A paraphrased version of those examples is given as follows: A volume of 1,000 gallons of water in the saline feedwater with a dissolved salt concentration of 20,000 ppm is mixed with 1,000 gallons water in an ion-reduced saline water, also with a dissolved salt concentration 20,000 ppm, produced by the ED system during the previous cycle. This results in a combined volume of 2,000 gallons of water with a dissolved salt concentration of 20,000 ppm, which is then fed to the RO system. With a water recovery factor of 0.5, the RO produces 1,000 gallons of desalinated water and 1,000 gallons of water as part of ion-enriched water (wastewater) with a dissolved salt concentration of 40,000 ppm. The ED system then reduces the ion content of this 40,000-ppm ion-enriched water stream back to 20,000 ppm, preparing it for use in the next operating cycle. Furthermore, during the ED process, the ions in the ion-enriched water are passed to the slightly supersaturated ED concentrate water stream, which precipitates excess dissolved salt ions onto salt crystals, producing approximately (8.3×0.02×1,000) pounds of solid salt. A more detailed explanation of this process is provided later in the document.

This invention expands the CERO system to accommodate any RO permissible water recovery factor (usually between 0 and 1). It also introduces a CERO implementation in which all operations within the cyclic process can be carried out concurrently rather than sequentially.

### BRIEF SUMMARY OF THE INVENTION

The patent applications cited in the Introduction describe a Combined Electrodialysis and Reverse Osmosis (CERO) system capable of achieving 100% recovery of the water in the saline feedwater and only solid salt as waste, but their scope was limited. They presented only a single illustrative case in which the Reverse Osmosis (RO) system operated at a 50% water recovery factor, and they offered little guidance on how the system could be implemented beyond noting that the serial CERO operations could be performed sequentially. This invention significantly broadens the scope of the CERO system by enabling the RO subsystem to operate with any RO permissible water recovery factor. It also introduces an alternative implementation in which all operations within a CERO cycle can be executed concurrently, rather than strictly in series.

Each cycle of the serial CERO operations proceeds as follows. The system combines the saline feedwater with the ion-reduced saline water produced by the electrodialysis (ED) dilute water stream during the previous cycle. This combined saline water stream is sent to the RO subsystem, which produces desalinated water and an ion-enriched water (wastewater) stream. The RO ion-enriched water stream is then fed to the ED subsystem, which reduces its TDS back to that of the original feedwater by transferring the ions to the concentrate water of the ED system where they are converted to solid salt in its concentrate water tank. The resulting ion-reduced saline water is returned to the combiner for use in the next cycle. All operations are carried out sequentially, and the full sequence is repeated for each cycle.

The input saline feedwater has a water mass of mₒ with a TDS of Sₒ. The fractional number r, of any permissible value (usually between 0 and 1), is the fractional amount of water in the saline feedwater sent to the RO that is recovered as desalinated water by the RO system. To recover all the water from the CERO input saline feedwater, the RO must input a water mass of

$$( 1 / r ) {m}_{o}$$

so that the output water mass of the RO system is mₒ. To cause this to happen the ED system must provide a water mass in the ion-reduced water of

$$\{ ( 1 - r ) / r \} {m}_{o} ,$$

which is the mass of the water sent from the ED system on the previous cycle of operation. After the combiner, the water mass can be written as:

$${m}_{o} . + \{ ( 1 - r ) / r \} {m}_{o} = ( 1 / r ) {m}_{o} .$$

Because the mass of the salt ions in the ion-reduced water is required to be the same TDS Sₒ as the saline feedwater, the dissolved salt mass in the ion-reduced water is:

$$\{ ( 1 - r ) / r \} {S}_{o} {m}_{o}$$

After combining the salt ions from the saline feedwater and the ion-reduced water from the ED system, the mass of the salt ions in the input water to the RO is

$$( 1 / r ) {S}_{o} {m}_{o} .$$

One output of the RO system is desalinated water having a water mass of mₒ. The other output of the RO is ion-enriched water sent to the dilute water of the ED system. The water mass of the ion-enriched water is

$$\{ ( 1 - r ) / r \} {m}_{o} .$$

Since all the mass of the salt ions are in the ion-enriched water given by

$$( 1 / r ) {S}_{o} {m}_{o} ,$$

the TDS of the ion-enriched water is the ratio of these two valves to given by:

$${S}_{o} / ( 1 - r ) .$$

The ED system reduces the TDS of its ion-enriched dilute water by passing the ions with a mass of
Sₒ mₒ
over to its slightly supersaturated concentrate water which flows through salt crystals in the concentrate water tank and the excess ions precipitate into solid salt with the same mass as the ions. After the ED operation on the ion-enriched dilute water, the resulting ion-reduced saline dilute water has a

$$water mass of \{ ( 1 - r ) / r \} {m}_{o}$$

$$and$$

$$salt mass of \{ ( 1 - r ) / r \} {S}_{o} {m}_{o}$$

This saline water from the ED system is made available to be used in the coming operation on the next cycle of the CERO system. The description of the CERO system with examples is subsequently given in more depth.

A CERO system implementation, that allows all the operations in a cycle to operate concurrently is given. This is accomplished by introducing two dilute water tanks. On one cycle, the operations are: (1) combining the input feedwater with ion-reduced dilute water from the previous cycle of the ED system in the first tank, (2) feeding the water in the first tank through the RO system, (3) outputting desalinated water, and (4) sending the RO ion-enriched water to the second tank. The ED system reduces the TDS of this ion-enriched water (waste water) in the second tank for the next cycle of operation by passing those ions to slightly supersaturated concentrate water of the ED system where they precipitate onto salt crystals held in the concentrate water tank. These operations are repeated after switching the roles of the two tanks and then the two sets of operations are continually repeated.

### BRIEF DESCRIPTION OF THE SEVERAL VIEWS OF THE DRAWING(S)

FIG. 1: Functional Block Diagram of the Combined Electrodialysis and Reverse Osmosis (CERO) system

FIG. 2: Table showing CERO system's water volume and TDS as function of location within CERO, feedwater's volume of 1,000 gallons and TDS of 20,000 ppm, and for the RO to recover r=0.5 of its input water as desalinated water (Note the CERO system recovers 100% of its input water as desalinated water)

FIG. 3: Table showing CERO system's water mass, salt mass, and TDS as function of location within CERO, feedwater's water mass of mₒ, feedwater's salt mass Sₒ mₒ, feedwater's TDS Sₒ, and for the RO to recover the fractional r part of its input water as desalinated water (Note the CERO system recovers 100% of its input water as desalinated water and 100% of the input water's dissolved salt as solid salt.)

FIG. 4: Table showing CERO system's water volume/mass, salt mass, and TDS as function of location within CERO, feedwater's water volume 1,000 gallons/mass 8,340 lbs., feedwater's salt mass 167 lbs., feedwater's TDS 20,000 ppm=0.02, and for the RO to recover the fractional r=0.5 part of its input water as desalinated water

FIG. 5: Table showing CERO system's water volume/mass, salt mass, and TDS as function of location within CERO, feedwater's water volume 1,000 gallons/mass 8,340 lbs., feedwater's salt mass 83.4 lbs,, feedwater's TDS 10,000 ppm=0.01, and for the RO to recover the fractional r=0.6 part of its input water as desalinated water

FIG. 6: Combined Electrodialysis Reverse Osmosis CERO system using concurrent operations

### DETAILED DESCRIPTION OF THE INVENTION

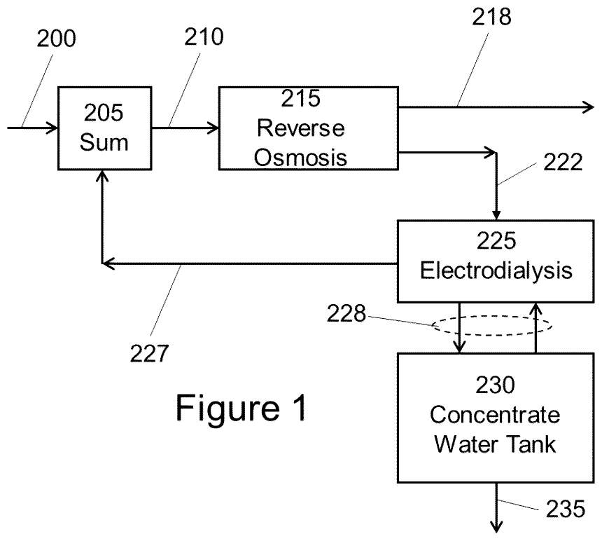

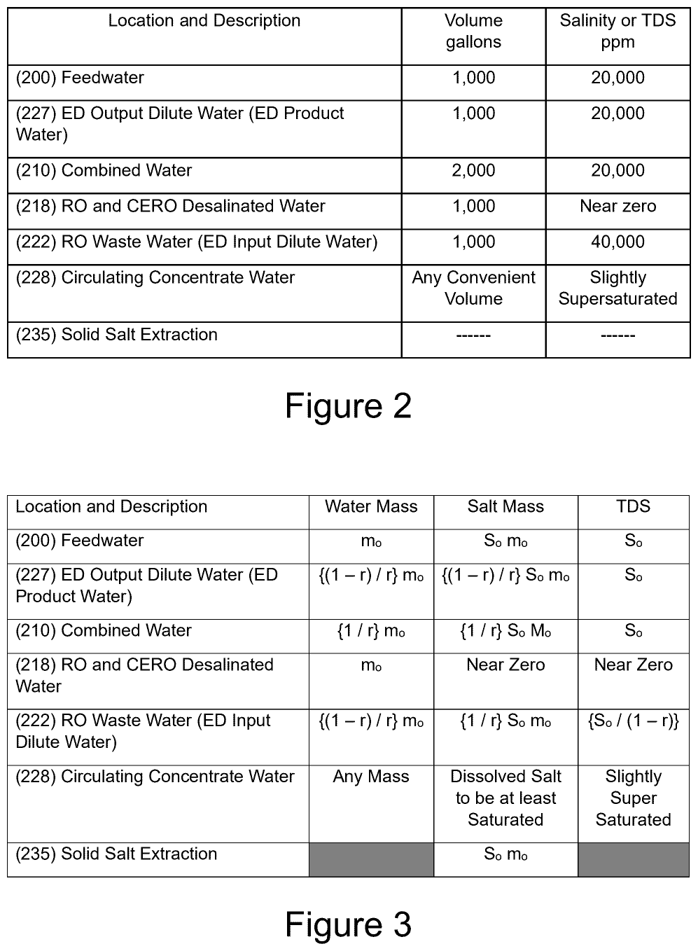

Before providing the description of this invention, the paraphrased example from previous patent applications discussed in the introduction is discussed in more detail. Referring to FIG. 1, in each operating cycle, 1,000 gallons of water in the saline feedwater 200, along with the dissolved salt having a TDS of 20,000 ppm, enters the CERO system. This feedwater 200 is combined at step 205 with 1,000 gallons of water along with dissolved salt having a TDS of 20,000 ppm in the ion-reduced dilute water 227 produced by the Electrodialysis (ED) system 225 during the previous cycle. The ion-reduced dilute water 227 from the ED 225 also has a TDS of 20,000 ppm, so the combined water stream 210 consists of 2,000 gallons of water in the saline water at 20,000 ppm TDS. This combined saline water stream 210 passes through the reverse osmosis (RO) system 215, which recovers 50% of the incoming water as desalinated product water 218 with near-zero TDS. The RO product water 218 has a volume of 1,000 gallons of water (half of the water in the saline feedwater 210 to the RO system 215). The RO ion-enriched water (wastewater) stream 222, also has 1,000 gallons of water (half of the water in the saline feedwater 210 to the RO system 215), contains all salts in the RO feedwater 210 and therefore has a TDS of 40,000 ppm. This RO ion-enriched water 222 is routed to the dilute water stream of the ED system 225, which transfers half of the ions to the concentrate water 228 of the ED system 225 and returns the ion-reduced dilute water 227 to 20,000 ppm TDS. This ion-reduced dilute water 227 is then available for the next cycle. During ED system 225 operation, the slightly supersaturated concentrate water 228, which remains below the threshold of spontaneous crystallization, circulates between the ED system 225 and the Concentrate Water Tank 230. As this concentrate water passes 228 through the salt crystals stored in the Concentrate Water Tank 230, excess ions precipitate onto the crystal surfaces, increasing their mass. Solid salt 235 is periodically removed from the Concentrate Water Tank 230. A summary of these operations is provided in the table shown in FIG. 2.

This invention extends the scope of the CERO system beyond the previous example in which the reverse osmosis (RO) unit operates only at a RO fractional water recovery of r=0.5. The CERO capability, that obtains 100% recovery of the water in the saline feedwater leaving only solid salt as waste is maintained while the RO fractional water recovery r may now take any permissible value (usually between 0 and 1). Referring to FIG. 1, at the start of each cycle, the saline feedwater 200 contains
water mass mₒ and
dissolved salt mass Sₒ mₒ.
where Sₒ is the TDS of the saline feedwater. The TDS Sₒ is defined as the ratio of the mass of dissolved salt to the mass of water, both in the saline feedwater 200. This saline feedwater 200 is combined 205 with the ion-reduced dilute water 227 produced by the ED system 225 during the previous cycle. The ion-reduced dilute water 227 has:

$$\begin{matrix}water mass of \{ ( 1 - r ) / r \} {m}_{o} , and \\ dissolved salt mass of \{ ( 1 - r ) / r \} {S}_{o} {m}_{o}\end{matrix}$$

so that its TDS remains Sₒ. The combined saline water stream 210 therefore has:

$$\begin{matrix}total water mass of ( 1 / r ) {m}_{o} , and \\ total dissolved salt mass of ( 1 / r ) {S}_{o} {m}_{o} ,\end{matrix}$$

and thus retains a TDS of Sₒ. This combined water stream 210 is fed to the RO system 215, which operates at a fractional recovery r. The RO system 215 produces two output streams:
1. Desalinated water 218, containing:
   water mass of mₒ, and
   no dissolved salt, (TDS effectively zero).
2. RO ion-enriched water 222, which contains:

$$\begin{matrix}water mass of \{ ( 1 - r ) / r \} {m}_{o} , and \\ dissolved salt mass of \{ ( 1 - r ) / r \} {S}_{o} {m}_{o}\end{matrix}$$

$$giving a TDS of {S}_{o} / ( 1 - r ) .$$

This RO ion-enriched water 222 enters the dilute water container of the ED system 225. The ED system 225 transfers a
mass of Sₒ mₒ
of salt ions into its slightly supersaturated concentrate water. After the transfer of salt ions, the resulting ion-reduced dilute water 227 retains the same

$$water mass \{ ( 1 - r ) / r \} {m}_{o} ,$$

but now contains a dissolved salt mass of

$$\{ ( 1 - r ) / r \} {S}_{o} {m}_{o} ,$$

returning its TDS to Sₒ. This ion-reduced dilute water 227 is stored for the next cycle of the CERO process.

Meanwhile, slightly supersaturated concentrate water 228 circulates between the ED system 225 and the Concentrate Water Tank 230. As this solution passes through the salt crystals in the Concentrate Water Tank 230, excess dissolved salt ions precipitate onto the crystals. In each cycle, a
total salt mass of Sₒ mₒ
precipitates as solid salt. This solid salt 235 is periodically removed from the system. The water masses, salt masses, and corresponding TDS values at each step in the process are summarized in FIG. 3. Importantly, in each complete cycle, all the water entering as part of the saline feedwater 200 is recovered as desalinated product water 218, and all the dissolved salt in the feedwater 200 is recovered as solid salt 235.

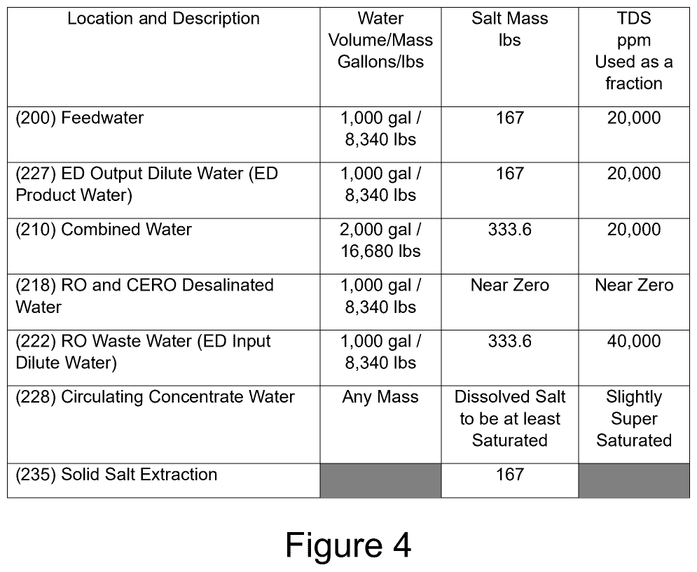

Referring to FIG. 3, the water masses shown there can be expressed as volumes by multiplying each water mass by the appropriate conversion factor from pounds to gallons. In FIG. 4, this conversion has been applied, and therefore the first column lists both the water volume (in gallons) and the corresponding water mass for clarity. By inserting 1,000 gallons water in the saline feedwater 200 with a TDS of 20,000 ppm (0.02) and an RO fractional water recovery of r=0.5 into the equations summarized in FIG. 3, one obtains the numerical results shown in FIG. 4. The data common to FIGS. 2 and 4 match exactly, demonstrating that the example in FIG. 2 is simply a special case of the more general formulation provided in FIG. 3.

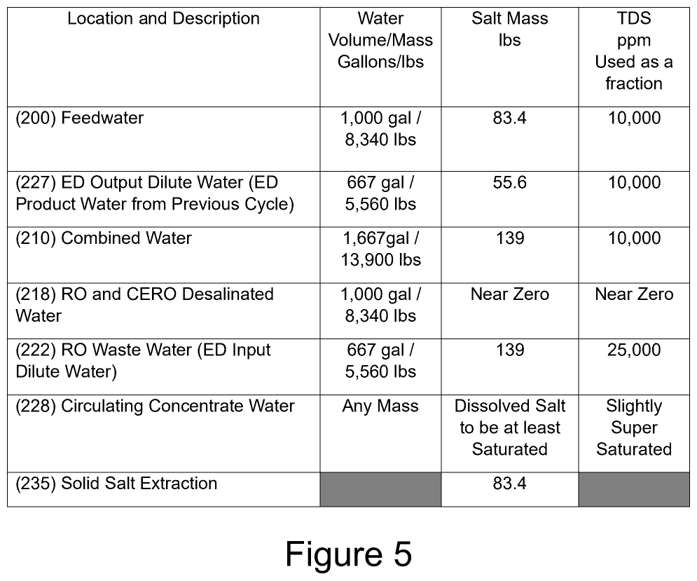

For illustration, FIG. 5 presents the results of the CERO process when the saline feedwater 200 volume is again 1,000 gallons, but with a TDS of 10,000 ppm and an RO recovery of r=0.6. In all cases shown in FIGS. 2, 3, 4, and 5, the system recovers all the water in the saline feedwater 200 as desalinated product water 218, and all the dissolved salt in the feedwater is recovered as solid salt 235.

This invention also extends the functional description of the CERO system, which recovers 100% of the water in the saline feedwater as desalinated water and converts all dissolved salts to solid salt, to include a practical, implementable configuration of the system. In earlier descriptions, the CERO process was presented as a sequence of discrete steps performed within each operational cycle. The following section presents an implementation in which these steps are carried out concurrently within a cycle, enabling continuous and practical operation of the CERO system.

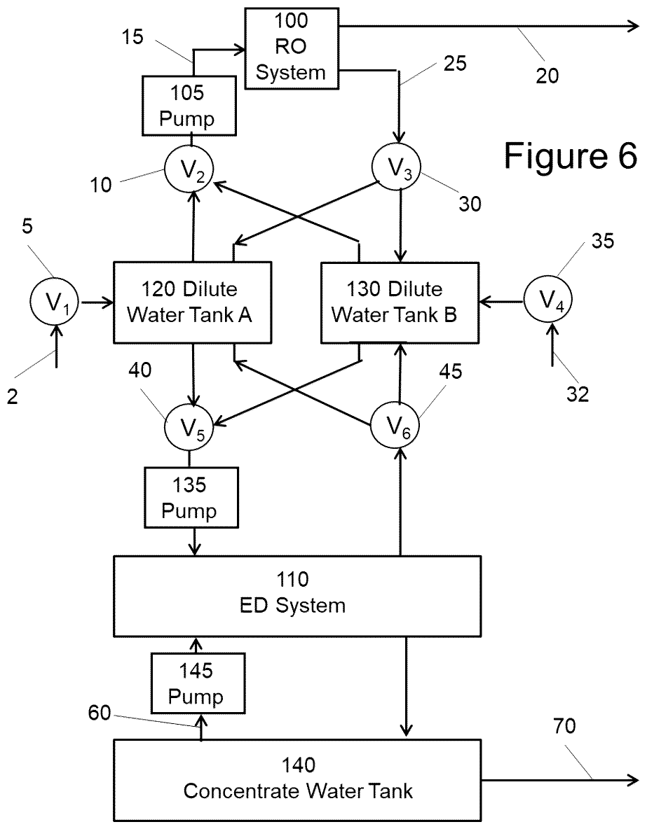

Referring to FIG. 6, the CERO system operates continuously by cycling between two process states, X and Y, in a repeating sequence: X, Y, X, Y . . . . For all equations, the total dissolved solids (TDS) concentration in parts per million is expressed in its fractional form (e.g., 20,000 ppm is written as 0.02). Likewise, the reverse osmosis (RO) water recovery factor r is expressed as a fraction (e.g., 60% is written as r=0.6).
CERO system condition leaving State Y and entering State X
   RO Pump 105, Dilute Water Pump 135, ED system 110 and Concentrate Water Pump 145 are all OFF,
   ON/OFF Valves 5 and 35 are closed,
   Diverter Valves 10, 30, 40, and 45 are in the position for the previous State Y operations,
   Dilute Water Tank A 120 has

$$\{ ( 1 - r ) / r \} {m}_{o} mass of dilute water ,$$

TDS of Sₒ, and

$$\{ ( 1 - r ) / r \} {S}_{o} {m}_{o} , mass of dissolved salt .$$

Dilute Water Tank B 130 is empty,
Startup and Operation for State X where all the operations are performed concurrently
   Diverter Valve 10 is changed to draw water from the Dilute Water Tank A 120 and send this ion-reduced dilute water through the RO Pump 105 to the saline water 15 feeding the RO system 100,
   Diverter Valve 30 is changed to send the RO 100 ion-enriched water 25 through an air gap to the top of the Dilute Water Tank B 130,
   Diverter Valve 40 is changed to send dilute water from the Dilute Water Tank B 130 to the Dilute Water Pump 135 to the ED 110 system,
   Diverter Valve 45 is changed to send dilute water from the ED system 110 through an air gap to the top of the Dilute Water Tank B 130,
   RO Pump 105, Dilute Water Pump 135, ED system 110, and Concentrate Water Pump 145 are turned on.
   ON/OFF Valve 5 is opened and
      mₒ mass of water plus
      Sₒ mₒ dissolved salt mass
in the saline feedwater 2 with a TDS of Sₒ is let into the Dilute Water Tank A 120 during the time of State X. This adds saline feedwater 2 to the ion-reduced dilute water already in Dilute Water Tank A 120, which has

$$\begin{matrix}water mass of \{ ( 1 - r ) / r \} {m}_{o} and \\ salt mass of TDS of \{ ( 1 - r ) / r \} {S}_{o} {m}_{o}\end{matrix}$$

to give a total

$$\begin{matrix}water mass of \{ 1 / r \} {m}_{o} and \\ salt mass of \{ 1 / r \} {S}_{o} {m}_{o}\end{matrix}$$

by the time of the end of State X,
   The RO 100 is separating its input water stream 15 into a stream of desalinated water 20 and an ion-enriched water stream 25 going through Diverter Valve 30 to the Dilute Water Tank B 130 which is being operated on by the ED system 110,
   Pump 145 is pumping concentrate water 60 from the Concentrate Water Tank 140 into the ED system 110 and back to the Concentrate Water Tank 140,
   The ED system 110 is transferring ions from the dilute water found in the Dilute Water Tank B 130 to the concentrate water found in the Concentrate Water Tank 140,
   Because the concentrate water 60 is slightly supersaturated, the excess ions transferred into it by the ED system 110 precipitate onto salt crystals that are in the concentrate water flow path in the Concentrate Water Tank 140, which adds to the crystal's mass.
End of State X
   When Dilute Water Tank A 120 is empty, the RO pump 105 stops,
   the ED system 110 and the Dilute Water Pump 135 stop, when the Dilute water in Tank B 130 reaches

$$\begin{matrix}water mass of \{ ( 1 - r ) / r \} {m}_{o} and \\ dissolved salt mass \{ ( 1 - r ) / r \} {S}_{o} {m}_{o}\end{matrix}$$

where Sₒ is the TDS of the saline feedwater 2 or 32,
   When the RO Pump 105, Dilute Water Pump 135, and ED System 110 stop, Pump 145 stops, the end of State X is signaled, and it is time to move on to the next State Y,
   At the end of State X, the RO system 100 has produced a mass of mₒ of desalinated water 20 (Recovered all the water from the input saline feedwater), and
   At the end of State X, the Concentrate Water Tank 140, acting as a precipitator, has recovered
      Sₒ mₒ pounds
   of solid salt 70 (All the salt dissolved in the input saline feedwater).
CERO system condition leaving State X and entering State Y
   RO Pump 105, Dilute Water Pump 135, ED system 110 and Concentrate Water Pump 145 are all OFF,
   ON/OFF Valves 5 and 35 are closed,
   Diverter Valves 10, 30, 40, and 45 are in the position for the previous State X operations,
   Dilute Water Tank B 130 has

$$\{ ( 1 - r ) / r \} {m}_{o} mass of dilute water ,$$

TDS of Sₒ, and

$$\{ ( 1 - r ) / r \} {S}_{o} {m}_{o} , mass of dissolved salt .$$

Dilute Water Tank A 120 is empty,
Startup and Operation for State Y where all the operations are performed concurrently
   Diverter Valve 10 is changed to draw water from the Dilute Water Tank B 130 and send this dilute water through the RO Pump 105 to the saline water 15 feeding the RO system 100,
   Diverter Valve 30 is changed to send the RO 100 ion-enriched water 25 through an air gap to the top of the Dilute Water Tank A 120,
   Diverter Valve 40 is changed to send dilute water from the Dilute Water Tank A 120 to the Dilute Water Pump 135 to the ED 110 system,
   Diverter Valve 45 is changed to send dilute water from the ED system 110 through an air gap to the top of the Dilute Water Tank A 120,
   RO Pump 105, Dilute Water Pump 135, ED system 110, and Concentrate Water Pump 145 are turned on.
   ON/OFF Valve 35 is opened and
      mₒ mass of water plus
      Sₒ mₒ dissolved salt mass
in the saline feedwater 32 with a TDS of Sₒ is let into the Dilute Water Tank B 130 during the time of State Y. This adds saline feedwater 32 to the ion-reduced dilute water already in Dilute Water Tank B 130, which has

$$\begin{matrix}water mass of \{ ( 1 - r ) / r \} {m}_{o} and \\ salt mass of TDS of \{ ( 1 - r ) / r \} {S}_{o} {m}_{o}\end{matrix}$$

to give a total

$$\begin{matrix}water mass of \{ 1 / r \} {m}_{o} and \\ salt mass of \{ 1 / r \} {S}_{o} {m}_{o}\end{matrix}$$

by the time of the end of State Y,
   The RO 100 is separating its input water stream 15 into a stream of desalinated water 20 and an ion-enriched water stream 25 going through Diverter Valve 30 to the Dilute Water Tank A 120 which is being operated on by the ED system 110,
   Pump 145 is pumping concentrate water 60 from the Concentrate Water Tank 140 into the ED system 110 and back to the Concentrate Water Tank 140,
   The ED system 110 is transferring ions from the dilute water found in the Dilute Water Tank A 120 to the concentrate water found in the Concentrate Water Tank 140,
   Because the concentrate water 60 is slightly supersaturated, the excess ions transferred into it by the ED system 110 precipitate onto salt crystals that are in the concentrate water flow path in the Concentrate Water Tank 140, which adds to the crystal's mass.
End of State Y
   When Dilute Water Tank B 130 is empty, the RO pump 105 stops,
   the ED system 110 and the Dilute Water Pump 135 stop, when the Dilute water in Tank A 120 reaches

$$\begin{matrix}water mass of \{ ( 1 - r ) / r \} {m}_{o} and \\ dissolved salt mass \{ ( 1 - r ) / r \} {S}_{o} {m}_{o}\end{matrix}$$

where Sₒ is the TDS of the saline feedwater 2 or 32,
   When the RO Pump 105, Dilute Water Pump 135, and ED system 110 stop, Pump 145 stops, the end of State Y is signaled, and it is time to move on to the next State X,
   At the end of State Y, the RO system 100 has produced a mass of mₒ of desalinated water 20 (Recovered all the water from the input saline feedwater), and
   At the end of State Y, the Concentrate Water Tank 140, acting as a precipitator, has recovered
      Sₒ mₒ pounds
of solid salt 70 (All the salt dissolved in the input saline feedwater).
CERO system leaving State Y and entering State X

### Alternately Repeats States X and Y

1. The Combined Electrodialysis and Reverse Osmosis (CERO) system operates by combining a fixed amount of saline feedwater with ion-reduced dilute water produced by the Electrodialysis (ED) system on the previous CERO cycle of operations. This combined saline water is then fed to the Reverse Osmosis (RO) system. The RO system generates two outputs: (1) desalinated product water and (2) ion-enriched saline water. The ion-enriched saline water is routed to the dilute water of the ED system, where a fixed quantity of ions is transferred into a circulating concentrate water stream of the ED system. This concentrate water stream, which is slightly supersaturated, circulates through a concentrate water tank that contains salt crystals. As it passes through the crystals, the excess ions precipitate as solid salt. After ion removal, the dilute water stream of the ED system is left at a lower-salinity state and becomes ready for the next CERO cycle of operations. These operations can repeat either sequentially as stated or simultaneously with a modified system. When the masses of the water and dissolved salts are appropriately controlled throughout the CERO system, the CERO system can provide 100% recovery of the water in the input saline feedwater and all the dissolved salt in the input saline feedwater as solid salt.

2. When the CERO system is operated cyclically using a series of repeated sequential operations within each cycle and meets specified water requirements for each operation, it can achieve 100% recovery of the water in the input saline feedwater and complete recovery of all dissolved salts as solid salt. Each cycle processes a fixed quantity of saline feedwater consisting of:
water mass mₒ and
dissolved salt mass Sₒ mₒ
where Sₒ is the Total Dissolved Solids TDS in ppm (Example 20,000 ppm=0.02). By definition, Sₒ equals the mass of dissolved salt divided by the mass of the water. Within each cycle, the RO system recovers any permissible fraction r of the water entering the RO unit as desalinated product water. The CERO cycle consists of the following serial operations, each with corresponding water and salt mass requirements:
The saline feedwater containing a
mass mₒ of water and
mass Sₒ mₒ of dissolved salt
is combined with the ion-reduced dilute water carried over from the previous cycle of the ED system. This ion-reduced dilute water of the ED system is composed of
$$\begin{matrix}mass \{ ( 1 - r ) / r \} {m}_{o} of water and \\ mass \{ ( 1 - r ) / r \} {S}_{o} {m}_{o} of salt ions\end{matrix}$$
giving it the same TDS Sₒ as the feedwater,
The resulting combined saline water therefore contains a
$$\begin{matrix}mass \{ 1 / r \} {m}_{o} of water and \\ mass \{ 1 / r \} {S}_{o} {m}_{o} of dissolved salt ,\end{matrix}$$
maintaining a TDS of Sₒ,
The combined saline water enters the RO system, which then produces two output water streams: (1) a desalinated product water steam containing a fraction r of its input water's mass and (2) ion-enriched water stream containing the remaining
$$fraction ( 1 - r )$$
of RO input water's mass together with essentially all the dissolved salt originally present in the RO feed. The desalinated water has a mass mₒ, which has the same mass mₒ as the mass of the water in the input saline feedwater, and contains essentially no dissolved salt (ions). The ion-enriched water stream passes to the dilute water of the ED system dilute water of the ED system. This ion-enriched dilute water consists of a
$$\begin{matrix}mass of water of \{ ( 1 - r ) / r \} {m}_{o} plus \\ mass of dissolved salt of \{ 1 / r \} {S}_{o} {m}_{o} ,\end{matrix}$$
which makes the
$$TDS of ion - enriched dilute water {S}_{o} / ( 1 - r ) ,$$
The ED system transfers a
mass Sₒ mₒ
of dissolved salt ions into its circulating concentrate water stream, that is circulating through the ED system and the Concentrate Water Tank. The concentrate water stream becomes slightly supersaturated, but still below the threshold where spontaneous precipitation would occur,
The slightly supersaturated concentrate water of the ED system flows through a bed of salt crystals that are in the concentrate water tank, causing the
mass Sₒ mₒ
of excess dissolved salt to precipitate onto these crystals and form additional solid salt,
The ion-reduced dilute water produced by the ED system, containing
$$\begin{matrix}water mass of \{ ( 1 - r ) / r \} {m}_{o} and \\ dissolved - salt mass of \{ ( 1 - r ) / r \} {S}_{o} {m}_{o}\end{matrix}$$
is then made ready for use in the next cycle of CERO operations, and . . . .
The previously described serial sequence of CERO operations is carried out repeatedly in a continuous cycle.

3. When the CERO system operates using a set of repeated, concurrent operations, each having the specified water requirements described herein, it can achieve 100% recovery of the water that is in the input saline feedwater, as well as completely recover all the dissolved salt that is in the input saline feedwater as solid salt. Each cycle processes a fixed quantity of saline feedwater consisting of a
water mass mₒ and
dissolved-salt mass Sₒ mₒ
where Sₒ is the Total Dissolved Solids (TDS) concentration in parts per million (ppm). The TDS value Sₒ is defined as the ratio of the dissolved salt mass to the water mass, and typically ranges from values between zero to one. The RO system recovers a fraction r of the water mass that is in the feedwater entering the RO unit as desalinated product water. The CERO system, using concurrent operations in each state X or Y, operates continuously by alternating between the two states, X and Y, in sequence: X, Y, X, Y, X, Y, . . . . The operations performed concurrently in each state, along with their respective water and salt mass requirements, are as follows:
X State
Initially, Tank A contains ion-reduced dilute water with a
$$\begin{matrix}water mass of \{ ( 1 - r ) / r \} {m}_{o} and \\ dissolved - salt mass of \{ ( 1 - r ) / r \} {S}_{o} {m}_{o} ,\end{matrix}$$
all carried over from the previous State Y, while Tank B is empty,
The valves are set so that the RO system draws water from Tank A and directs its RO ion-enriched water (wastewater) into Tank B,
The valves are set so that Tank B is connected to both the dilute-water inlet and outlet ports of the ED system,
Simultaneously, the RO and ED systems begin operating. Saline feedwater enters Tank A where it combines with the ion-reduced dilute water of the ED system produced on the previous cycle of operation and sends this combined saline water with
$$\begin{matrix}mass \{ 1 / r \} {m}_{o} of water and \\ mass \{ 1 / r \} {S}_{o} {m}_{o} of dissolved salt ,\end{matrix}$$
through the RO system,
The RO system produces nearly salt-free product desalinated water, and the RO ion-enriched water (wastewater) is directed into Tank B,
the ED system transfers ions from the ion-enriched dilute water from Tank B to the concentrate water of the ED system,
The slightly supersaturated concentrate water from the ED system circulates through the concentrate water tank, where a mass of
mass of Sₒ mₒ
of excess dissolved salt eventually precipitates onto the existing salt crystals and forms additional salt mass,
State X concludes when all the following conditions have been met:
When a
water mass mₒ and
dissolved salt mass Sₒ mₒ
in the input saline feedwater with TDS Sₒ has entered Tank A, Tank A is now empty, and the RO system has produced a mass mₒ of desalinated product water, then the RO system operation stops,
Tank B, which is connected to the ED system, has received the full RO ion-enriched water (wastewater) stream consisting of a
$$\begin{matrix}water mass of \{ ( 1 - r ) / r \} {m}_{o} and \\ dissolved - salt mass of \{ ( 1 - r ) / r \} {S}_{o} {m}_{o} ,\end{matrix}$$
The ED system has removed a
dissolved salt mass Sₒ mₒ
from Tank B and transferred it to its concentrate water stream of the ED system, leaving Tank B with a remaining
$$\begin{matrix}water mass of \{ ( 1 - r ) / r \} {m}_{o} and \\ dissolved - salt mass of \{ ( 1 - r ) / r \} {S}_{o} {m}_{o} ,\end{matrix}$$
at a TDS of Sₒ. This ion-reduced dilute water in Tank B is made available for the next State Y operation and the ED system stops.
The RO system must stop before the ED system stops, but for the most part they are both operating at the same time.
Y State
Initially, Tank B contains ion-reduced dilute water with a
$$\begin{matrix}water mass of \{ ( 1 - r ) / r \} {m}_{o} and \\ dissolved - salt mass of \{ ( 1 - r ) / r \} {S}_{o} {m}_{o} ,\end{matrix}$$
all carried over from the previous State X, while Tank A is empty,
The valves are set so that the RO system draws water from Tank B and directs its RO ion-enriched water (wastewater) into Tank A,
The valves are set so that Tank A is connected to both the dilute-water inlet and outlet ports of the ED system,
Simultaneously, the RO and ED systems begin operating. Saline feedwater enters Tank B where it combines with the ion-reduced dilute water of the ED system produced on the previous cycle of operation and sends this combined water with
$$\begin{matrix}mass \{ 1 / r \} {m}_{o} of water and \\ mass \{ 1 / r \} {S}_{o} {m}_{o} of dissolved salt ,\end{matrix}$$
through the RO system,
The RO system produces nearly salt-free product desalinated water, and the RO ion-enriched water (wastewater) is directed into Tank A,
the ED system transfers ions from the ion-enriched dilute water from Tank A to the concentrate water of the ED system,
The slightly supersaturated concentrate water from the ED system circulates through the concentrate water tank, where a
mass of Sₒ mₒ
of excess dissolved salt eventually precipitates onto the existing salt crystals and forms additional salt mass,
State Y concludes when all the following conditions have been met:
When
water mass mₒ and
dissolved salt mass Sₒ mₒ
in the input saline feedwater with TDS Sₒ has entered Tank B, Tank B is now empty, and the RO system has produced a mass mₒ of desalinated product water, then the RO system operation stops,
Tank A, which is connected to the ED system, has received the full RO ion-enriched water (wastewater) stream consisting of a
$$\begin{matrix}water mass \{ ( 1 - r ) / r \} {m}_{o} and \\ dissolved - salt mass of \{ 1 / r \} {S}_{o} {m}_{o} ,\end{matrix}$$
The ED system has removed a dissolved salt
mass Sₒ mₒ
from Tank A and transferred it to its concentrate water stream of the ED system, leaving Tank A with a remaining
$$\begin{matrix}water mass of \{ ( 1 - r ) / r \} {m}_{o} and \\ dissolved - salt mass of \{ ( 1 - r ) / r \} {S}_{o} {m}_{o}\end{matrix}$$
at a TDS of Sₒ. This ion-reduced dilute water in Tank A is made available for the next State X operation and the ED system stops.
The RO system must stop before the ED system stops, but for the most part they are both operating at the same time.
